(19) United States
(12) Patent Application Publication
(10) Pub. No.: US 2026/0087578 A1
(43) Pub. Date: Mar. 26, 2026

(54) METHOD FOR ZONING AND GRADING EVALUATION OF GROUNDWATER POLLUTION IN INDUSTRIAL AGGLOMERATION AREA

(71) Applicants: BCEG ENVIRONMENT REMEDIATION CO., LTD., Beijing (CN); BEIJING CONSTRUCTION ENGINEERING ECOLOGICAL RESTORATION LABORATORY TECHNOLOGY CO., LTD, Beijing (CN)

(72) Inventors: Shupeng LI, Beijing (CN); Beili WANG, Beijing (CN); Lili GUO, Beijing (CN); Qian SONG, Beijing (CN); Yameng HAN, Beijing (CN); Ting QU, Beijing (CN)

(21) Appl. No.: 19/405,352

(22) Filed: Dec. 1, 2025

Related U.S. Application Data
(63) Continuation of application No. PCT/CN2023/127841, filed on Oct. 30, 2023.

(30) Foreign Application Priority Data
Jun. 2, 2023 (CN) 202310645024.1

(51) Int. Cl. G06Q 50/26

(52) U.S. Cl. CPC G06Q 50/265

(57) ABSTRACT

A method for zoning and grading evaluation of groundwater pollution in an industrial agglomeration area, in which current enterprise data information of a plurality of enterprises within the industrial agglomeration area is acquired; potential pollution-emitting enterprises are screened based on the current enterprise data information; a pollution monitoring network is constructed based on the potential pollution-emitting enterprises; pollution monitoring data information is acquired through the pollution monitoring network; soil pollution data information of areas near the potential pollution-emitting enterprises is acquired; based on the pollution monitoring data information and the soil pollution data information, groundwater pollution within the industrial agglomeration area is evaluated to obtain an evaluation result; when the evaluation result is greater than a preset evaluation threshold, a graded early-warning signal is generated based on the evaluation result, and a remediation strategy is generated based on the graded early-warning signal.

### CROSS-REFERENCE TO RELATED APPLICATIONS

This application is a continuation of International Patent Application No. PCT/CN2023/127841, filed on Oct. 30, 2023, which claims the benefit of priority from Chinese Patent Application No. 202310645024.1, filed on Jun. 2, 2023. The content of the aforementioned application, including any intervening amendments thereto, is incorporated herein by reference in its entirety.

### TECHNICAL FIELD

This application relates to pollution early warning, and more particularly to a method for zoning and grading evaluation of groundwater pollution in an industrial agglomeration area.

### BACKGROUND

Water resources are the most important resources on Earth, among which freshwater resources are the most precious part. Approximately 29% of freshwater resources are stored underground, commonly referred to as groundwater. At present, due to various human living and production activities, the surface environment has been continuously damaged, which has, to a certain extent, affected the safety of the groundwater environment and made the problem of groundwater pollution increasingly severe. Compared with surface water, groundwater has poor mobility, low permeability, and limited exchange capacity. Therefore, once groundwater is polluted, it not only affects normal use but is also difficult to remediate effectively. Groundwater pollution caused by industrial production activities mainly results from the direct discharge of various types of wastewaters generated during industrial production without proper treatment. Various industrial and mining enterprises produce large amounts of waste residue, wastewater, and industrial garbage during production, which usually contain large quantities of harmful substances. If these harmful pollutants are not properly treated and are discharged directly, they not only pollute surface water but can also infiltrate into the ground, causing severe groundwater contamination. However, groundwater pollution is closely related to soil permeability. Currently, most groundwater pollution monitoring focuses on monitoring water bodies. When pollution is detected in a water body, it indicates that groundwater contamination has already occurred, making it impossible to detect or address the problem in advance.

### SUMMARY

An object of the disclosure is to provide a method for zoning and grading evaluation of groundwater pollution in an industrial agglomeration area to overcome the defects in the prior art.

Technical solutions of the present disclosure are described as follows.

In a first aspect, this application provides a method for zoning and grading evaluation of groundwater pollution in an industrial agglomeration area, comprising:
acquiring current enterprise data information of a plurality of enterprises within the industrial agglomeration area; and screening potential pollution-emitting enterprises based on the current enterprise data information;
constructing a pollution monitoring network based on the potential pollution-emitting enterprises; acquiring pollution monitoring data information through the pollution monitoring network; and acquiring soil pollution data information of areas near the potential pollution-emitting enterprises;
evaluating groundwater pollution within the industrial agglomeration area based on the pollution monitoring data information and the soil pollution data information to obtain an evaluation result; and
when the evaluation result is greater than a preset evaluation threshold, generating a graded early-warning signal based on the evaluation result, and generating a remediation strategy based on the graded early-warning signal.

In some embodiments, the step of screening the potential pollution-emitting enterprises based on the current enterprise data information of the plurality of enterprises within the industrial agglomeration area:
performing feature extraction on the current enterprise data information to determine a production type for each of the plurality of enterprises within the industrial agglomeration area; and acquiring, via big data analysis, a production type set related to groundwater pollution;
determining whether the production type of each of the plurality of enterprises within the industrial agglomeration area falls within the of production type set related to groundwater pollution;
if a production type of an enterprise among the plurality of enterprises is not within the production type set related to groundwater pollution, identifying the enterprise as a potential pollution-free enterprise;
if a production type of an enterprise among the plurality of enterprises is within the production type set related to groundwater pollution, acquiring production process information of the enterprise; obtaining, through the big data analysis, a product data associated with the production process information; analyzing, using a gray relational analysis method, a correlation degree between the product data and groundwater pollution; and when the correlation degree is greater than a preset correlation threshold, identifying and outputting the enterprise as a potential pollution-emitting enterprise.

In some embodiments, the step of constructing the pollution monitoring network based on the potential pollution-emitting enterprises comprises:
acquiring a production equipment arrangement area and a production procedure for each of the potential pollution-emitting enterprises; and identifying a potential discharge procedure associated with groundwater pollution based on the production procedure;
generating a deployment area of a plurality of monitoring devices based on the production equipment arrangement area and the potential discharge procedure associated with groundwater pollution; and
evenly deploying the plurality of monitoring devices within the deployment area to generate a plurality of monitoring nodes; and constructing the pollution monitoring network based on the plurality of the monitoring nodes.

In some embodiments, the step of evaluating groundwater pollution within the industrial agglomeration area based on the pollution monitoring data information and the soil pollution data information to obtain the evaluation result comprises:
acquiring, via big data analysis, migration characteristic information of a plurality of pollutants in different soil types; constructing a pollutant information database; inputting concentration information of each of the plurality of pollutants in the different soil types into the pollutant information database for storage;
acquiring a soil type of each of the potential pollution-emitting enterprises based on the soil pollution data information; and inputting soil types of the potential pollution-emitting enterprises into the pollutant information database for matching, so as to obtain a soil pollution concentration information of each of the potential pollution-emitting enterprises;
when the pollution monitoring data information is greater than the soil pollution concentration information, acquiring, via the big data analysis, a correlation between soil physicochemical data and the soil pollution concentration information of the potential pollution-emitting enterprises;
correcting a current pollution concentration information based on the correlation between the soil physicochemical data and the soil pollution concentration information of the potential pollution-emitting enterprises, so as to generate a corrected pollution concentration information; and
based on the corrected pollution concentration information and the pollution monitoring data information, evaluating the groundwater pollution within the industrial agglomeration area to obtain the evaluation result.

In some embodiments, the step of based on the corrected pollution concentration information and the pollution monitoring data information, evaluating the groundwater pollution within the industrial agglomeration area to obtain the evaluation result comprises:
acquiring soil survey data information of the industrial agglomeration area; and acquiring stratigraphic data based on the soil survey data information; and acquiring, through the big data analysis, a soil permeability coefficient for each stratum based on the stratigraphic data;
based on the soil permeability coefficient, calculating a permeation rate of water in soil;
predicting a diffusion condition of plurality of pollutants in the soil within a preset period based on the permeation rate of water in the soil and the corrected pollution concentration information; and
acquiring a diffusion condition at each depth gradient in the stratigraphic data based on the diffusion condition of the plurality of pollutants in the soil within the preset period; setting a plurality of evaluation indicators; and evaluating the diffusion condition at each depth gradient in the stratigraphic data based on the plurality of evaluation indicators to obtain the evaluation result.

In some embodiments, the step of generating the graded early-warning signal based on the evaluation result, and generating the remediation strategy based on the graded early-warning signal comprises:
collecting groundwater pollution evaluation results within the industrial agglomeration area; setting a plurality of groundwater evaluation indicators; and performing a groundwater pollution level evaluation on groundwater pollution survey data information of the industrial agglomeration area based on the plurality of groundwater evaluation indicators to generate a groundwater pollution level evaluation result;
based on the groundwater pollution level evaluation result, performing zoning and degrading early warning on the industrial agglomeration area to obtain an early-warning level for each groundwater pollution sub-area within the industrial agglomeration area;
acquiring a pollution type information of each groundwater pollution sub-area within the industrial agglomeration area; and acquiring, through big data analysis, a health hazard degree of each groundwater pollution sub-area based on the pollution type information of each groundwater pollution sub-area; and
generating a priority ranking result in a descending order based on the health hazard degree of each groundwater pollution sub-area; generating a priority remediation strategy based on the priority ranking result; and simultaneously generating a corresponding remediation strategy based on the pollution type information of each groundwater pollution sub-area.

In a second aspect, this application provides a system for zoning and grading evaluation of groundwater pollution in an industrial agglomeration area, comprising:
a memory having stored thereon a program; and
a processor;
wherein the program, when executed by the processor, is configured to cause the processor to perform steps of:
acquiring current enterprise data information of a plurality of enterprises within the industrial agglomeration area; and screening potential pollution-emitting enterprises based on the current enterprise data information;
constructing a pollution monitoring network based on the potential pollution-emitting enterprises; acquiring pollution monitoring data information through the pollution monitoring network; and acquiring soil pollution data information of areas near the potential pollution-emitting enterprises;
evaluating groundwater pollution within the industrial agglomeration area based on the pollution monitoring data information and the soil pollution data information to obtain an evaluation result; and
when the evaluation result is greater than a preset evaluation threshold, generating a graded early-warning signal based on the evaluation result, and generating a remediation strategy based on the graded early-warning signal.

In some embodiments, the step of evaluating groundwater pollution within the industrial agglomeration area based on the pollution monitoring data information and the soil pollution data information to obtain the evaluation result comprises:
acquiring, via big data analysis, migration characteristic information of a plurality of pollutants in different soil types; constructing a pollutant information database; inputting concentration information of each of the plurality of pollutants in the different soil types into the pollutant information database for storage;
acquiring a soil type of each of the potential pollution-emitting enterprises based on the soil pollution data information; and inputting soil types of the potential pollution-emitting enterprises into the pollutant information database for matching, so as to obtain a soil pollution concentration information of each of the potential pollution-emitting enterprise;
when the pollution monitoring data information is greater than the soil pollution concentration information, acquiring, via the big data analysis, a correlation between soil physicochemical data and the soil pollution concentration information of the potential pollution-emitting enterprises;
correcting a current pollution concentration information based on the correlation between the soil physicochemical data and the soil pollution concentration information of the potential pollution-emitting enterprises, so as to generate a corrected pollution concentration information; and
based on the corrected pollution concentration information and the pollution monitoring data information, evaluating the groundwater pollution within the industrial agglomeration area to obtain the evaluation result.

In some embodiments, the step of based on the corrected pollution concentration information and the pollution monitoring data information to obtain the evaluation result, evaluating the groundwater pollution within the industrial agglomeration area comprises:
acquiring soil survey data information of the industrial agglomeration area; and acquiring stratigraphic data based on the soil survey data information; and acquiring, through the big data analysis, a soil permeability coefficient for each stratum based on the stratigraphic data;
based on the soil permeability coefficient, calculating a permeation rate of water in soil;
predicting a diffusion condition of the plurality of pollutants in the soil within a preset period based on the permeation rate of water in the soil and the corrected pollution concentration information; and
acquiring a diffusion condition at each depth gradient in the stratigraphic data based on the diffusion condition of the plurality of pollutants in the soil within the preset period; setting a plurality of evaluation indicators; and evaluating the diffusion condition at each depth gradient in the stratigraphic data based on the plurality of evaluation indicators to obtain the evaluation result.

In a third aspect, this application provides a non-transitory computer-readable storage medium, the non-transitory computer-readable storage medium is configured for storing a program for zoning and grading evaluation of groundwater pollution in an industrial agglomeration area; and
the program is configured to be executed by a processor to implement the method described above.

Compared to the prior art, the present disclosure has the following beneficial effects.

In the present disclosure, current enterprise data information of a plurality of enterprises within the industrial agglomeration area is acquired. Potential pollution-emitting enterprises are screened based on the current enterprise data information. A pollution monitoring network is constructed based on the potential pollution-emitting enterprises. Pollution monitoring data information is acquired through the pollution monitoring network. Soil pollution data information of areas near the potential pollution-emitting enterprises is acquired. Groundwater pollution within the industrial agglomeration area is evaluated based on the pollution monitoring data information and the soil pollution data information to obtain an evaluation result. When the evaluation result is greater than a preset evaluation threshold, a graded early-warning signal is generated based on the evaluation result, and a remediation strategy is generated based on the graded early-warning signal. The disclosure fully takes into account the distribution of enterprises within the industrial agglomeration area, as well as the types and concentration levels of groundwater pollutants. A zoning evaluation of the industrial agglomeration area is performed according to the pollutant types and pollution levels, while the influence of soil physicochemical data on adsorption characteristics of the plurality of pollutants is also considered. Accordingly, soil pollution in areas near the potential pollution-emitting enterprises within the industrial agglomeration area is evaluated based on the adsorption characteristics, improving the accuracy of determining whether pollutants penetrate into groundwater, enabling the early assessment of whether pollutants may migrate through the soil into the groundwater layer, thereby preventing groundwater pollution incidents caused by soil contamination.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a flowchart of a method for zoning and grading evaluation of groundwater pollution in an industrial agglomeration area according to an embodiment of the present disclosure;

FIG. 2 is a flowchart of a direct relationship between enterprise production types and groundwater pollution;

FIG. 3 is a flowchart of the influence of soil types on groundwater pollution; and

FIG. 4 is a block diagram of a system for zoning and grading evaluation of groundwater pollution in an industrial agglomeration area according to an embodiment of the present disclosure.

### DETAILED DESCRIPTION OF EMBODIMENTS

For a clearer understanding of the above objectives, features and advantages of the present disclosure, the present disclosure will be described in further detail below in conjunction with the accompanying drawings and embodiments. It should be noted that, without conflict, the embodiments of the present disclosure and the features thereof may be combined with one another.

The following description discloses numerous specific details to facilitate a thorough understanding of the present disclosure. However, the present disclosure may be implemented in ways other than those described herein. Therefore, described herein are merely some embodiments of the present disclosure, rather than all embodiments. Based on the embodiments in the present disclosure, all other embodiments obtained by those of ordinary skill in the art without making creative effort shall fall within the scope of the present disclosure defined by the appended claims.

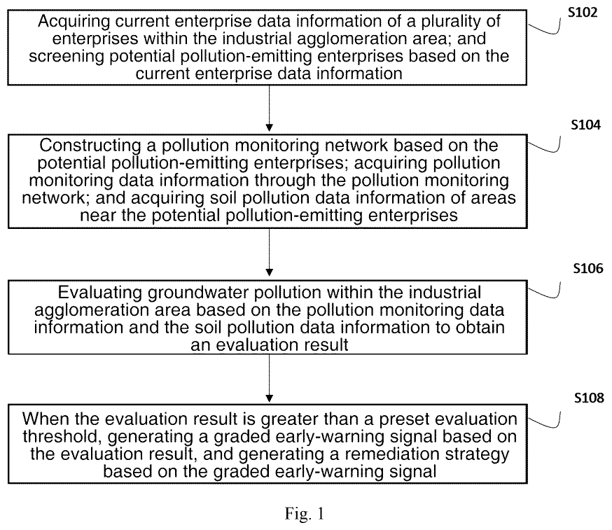

As shown in FIG. 1, an embodiment of the present disclosure provides a method for zoning and grading evaluation of groundwater pollution in an industrial agglomeration area, including the following steps.
(S102) Current enterprise data information of a plurality of enterprises within the industrial agglomeration area is acquired. Potential pollution-emitting enterprises are screened based on the current enterprise data information.
(S104) A pollution monitoring network is constructed based on the potential pollution-emitting enterprises. Pollution monitoring data information is acquired through the pollution monitoring network. Soil pollution data information of areas near the potential pollution-emitting enterprises is acquired.
(S106) Groundwater pollution within the industrial agglomeration area is evaluated based on the pollution monitoring data information and the soil pollution data information to obtain an evaluation result.
(S108) When the evaluation result is greater than a preset evaluation threshold, a graded early-warning signal is generated based on the evaluation result, and a remediation strategy is generated based on the graded early-warning signal.

It should be noted that the present disclosure fully takes into account the physicochemical properties of different soils, such as the content of organic carbon in the soil and its effect on the adsorption characteristics of various pollutants. Accordingly, soil pollution in areas near the potential pollution-emitting enterprises is evaluated based on the adsorption characteristics, improving the accuracy of determining whether pollutants penetrate into groundwater. In addition, corresponding remediation strategies and remediation priorities for soil restoration projects are provided, enabling the early assessment of whether pollutants may migrate through the soil into the groundwater layer, thereby preventing groundwater pollution incidents caused by soil contamination.

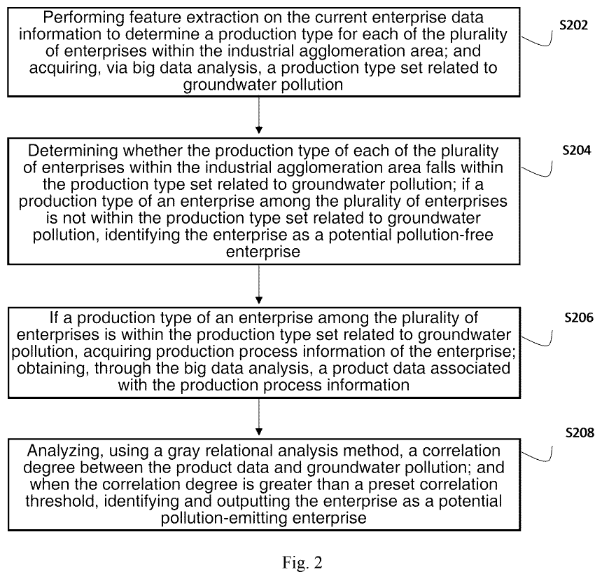

As shown in FIG. 2, in step (S102), the potential pollution-emitting enterprises are screened based on the current enterprise data information of the plurality of enterprises within the industrial agglomeration area through the following steps.
(S202) Feature extraction is performed on the current enterprise data information to determine a production type for each of the plurality of enterprises within the industrial agglomeration area. A production type set related to groundwater pollution is acquired via big data analysis.

In some embodiments, an enterprise engaged in heavy-metal manufacturing is classified as a production type related to groundwater pollution, whereas a laser enterprise that has only office areas is classified as a production type unrelated to groundwater pollution.
(S204) Whether the production type of each of the plurality of enterprises within the industrial agglomeration area falls within the production type set related to groundwater pollution is determined. If a production type of an enterprise among the plurality of enterprises is not within the production type set related to groundwater pollution, the enterprise is identified as a potential pollution-free enterprise.
(S206) If a production type of an enterprise among the plurality of enterprises is within the production type set related to groundwater pollution, production process information of the enterprise is acquired, and a product data associated with the production process information is obtained through the big data analysis.
(S208) A correlation degree between the product data and groundwater pollution is analyzed using a grey relational analysis method. When the correlation degree is greater than a preset correlation threshold, the enterprise is identified and output as a potential pollution-emitting enterprise.

It should be noted that the degree of association between factors of two systems, which varies over time or across different objects, is referred to as the correlation degree. During system development, if the variation trends of two factors are consistent, i.e., they exhibit a high degree of synchronous change, the correlation degree between them is considered high; otherwise, it is considered low. Accordingly, the grey relational analysis method is a method for evaluating the correlation degree between factors based on the similarity or dissimilarity of their development trends, referred to as the “grey relational degree.” The higher the correlation degree between the product data associated with the production process information and groundwater pollution, the higher the correlation degree between the enterprise's production process information and the groundwater pollution.
In step (S104), the pollution monitoring network is constructed based on the potential pollution-emitting enterprises through the following steps.

A production equipment arrangement area and a production procedure for each of the potential pollution-emitting enterprises are acquired. A potential discharge procedure associated with groundwater pollution are identified based on the production procedure.

A deployment area of a plurality of monitoring devices is generated based on the production equipment arrangement area and the potential discharge procedure associated with groundwater pollution.

The plurality of monitoring devices within the deployment area is evenly deployed to generate a plurality of monitoring nodes. The pollution monitoring network is constructed based on the plurality of monitoring nodes.

In some embodiments, the monitoring devices may include wireless sensors or specific monitoring devices independently developed by certain enterprises. The potential discharge procedure may include water discharge during production, disposal areas for production waste, or areas for placing defective products.

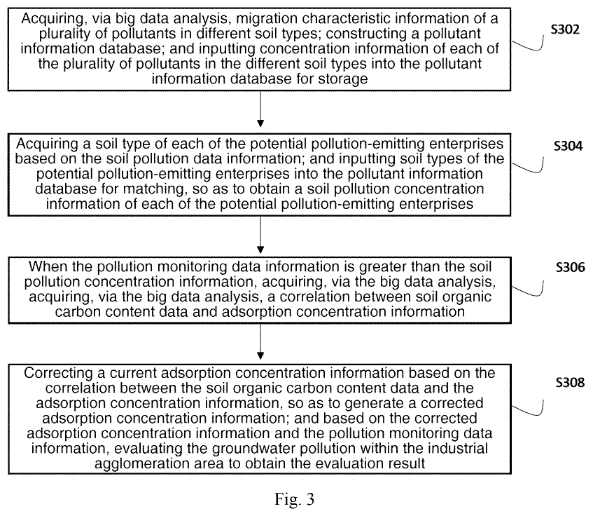

As shown in FIG. 3, in step (S106), groundwater pollution within the industrial agglomeration area is evaluated based on the pollution monitoring data information and the soil data information to obtain the evaluation result, including the following steps.
(S302) Migration characteristic information of a plurality of pollutants in different soil types is acquired via big data analysis. A pollutant information database is constructed. Concentration information of each of the plurality of pollutants in the different soil types is input into the pollutant information database for storage.
(S304) A soil type of each of the potential pollution-emitting enterprises is acquired based on the soil pollution data information. Soil types of the potential pollution-related enterprises are input into the pollutant information database for matching, so as to obtain a soil pollution concentration information of each of the potential pollution-emitting enterprises.

Exemplarily, in this embodiment, different soil types exhibit distinct adsorption characteristics for pollutants. For instance, in clay and silty clay soils, when pollutants such as benzene or toluene are present, even within a concentration of 500-2000 L/kg, the migration of benzene or toluene is very limited due to the adsorption characteristics of these soils, with the majority being adsorbed.
(S306) When the pollution monitoring data information is greater than the soil pollution concentration information, a correlation between soil organic carbon content data and adsorption concentration information is acquired via the big data analysis.

Exemplarily, in addition to soil type, the adsorption capacity of soil is closely related to the concentration of soil organic carbon. The higher the organic carbon content, the more readily pollutants are adsorbed onto the soil matrix, resulting in stronger adsorption by the soil and a larger range of pollutant concentrations that can be adsorbed per unit volume of soil. For example, clay with a certain concentration of organic carbon per unit volume can adsorb pollutants at an adsorption capacity of 600 L/kg.
(S308) A current adsorption concentration information is corrected based on the correlation between the soil organic carbon content data and the adsorption concentration information, so as to generate a corrected adsorption concentration information. Based on the corrected adsorption concentration information and the pollution monitoring data information, the groundwater pollution within the industrial agglomeration area is evaluated to obtain the evaluation result.

It should be noted that, through the present method, the current adsorption concentration information within the industrial agglomeration area can be corrected, thereby obtaining a final adsorption concentration information, which enables more accurate prediction of pollutant migration.

In an embodiment of the present disclosure, the groundwater pollution within the industrial agglomeration area is evaluated based on the corrected adsorption concentration information and the pollution monitoring data information to obtain the evaluation result, including the following steps.
Soil survey data information of the industrial agglomeration area is acquired. Stratigraphic data is acquired based on the soil survey data information. A soil permeability coefficient for each stratum is acquired through the big data analysis based on the stratigraphic data.
Based on the soil permeability coefficient, a permeation rate of water in soil.
A diffusion condition of the plurality of pollutants in the soil within a preset period is predicted based on the permeation rate of water in the soil and the corrected adsorption concentration information.
A diffusion condition at each depth gradient in the stratigraphic data is acquired based on the diffusion condition of the plurality of pollutants in the soil within the preset period. A plurality of evaluation indicators are set. The diffusion condition at each depth gradient in the stratigraphic data is evaluated based on the plurality of evaluation indicators to obtain the evaluation result.

It should be noted that different strata exhibit varying water permeability, meaning that the soil permeability coefficients are not uniform. Due to the adsorption characteristics of soil for pollutants, contaminants entering the soil are absorbed and retained within the soil. Assuming that each unit volume of soil can adsorb a certain amount of pollutants, the diffusion condition of the plurality of pollutants in the soil within the preset period can be predicted based on the permeation rate of water in the soil and the corrected adsorption concentration information. This method can further improve the accuracy of predicting pollutant diffusion in the soil. The soil survey data information includes stratigraphic structure data and physicochemical property data. Those skilled in the art can simulate pollutant diffusion using software such as Fluent.

In an embodiment of the present disclosure, the graded early-warning signal is generated based on the evaluation result, and the remediation strategy is generated based on the graded early-warning signal, including the following steps.
Groundwater pollution evaluation results within the industrial agglomeration area are collected. A plurality of groundwater evaluation indicators are set. A groundwater pollution level evaluation is performed on groundwater pollution survey data information of the industrial agglomeration area based on the plurality of groundwater evaluation indicators to generate a groundwater pollution level evaluation result.
Based on the groundwater pollution level evaluation result, zoning and degrading early warning is performed on the industrial agglomeration area to obtain an early-warning level for each groundwater pollution sub-area within the industrial agglomeration area.
A pollution type information of each groundwater pollution sub-area within the industrial agglomeration area is acquired. A health hazard degree of each groundwater pollution sub-area based on the pollution type information of each groundwater pollution sub-area is acquired through big data analysis.

A priority ranking result in a descending order is generated based on the health hazard degree of each groundwater pollution sub-area. A priority remediation strategy is generated based on the priority ranking result. A corresponding remediation strategy is simultaneously generated based on the pollution type information of each groundwater pollution sub-area.

For example, the early-warning levels include low, low-medium, medium, medium-high, and high early-warning levels. Pollutants that are about to diffuse into the groundwater layer are assigned a high early-warning level, while pollutants that are just on the soil surface are assigned a low early-warning level. Moreover, a priority ranking is established based on the degree of hazard of the pollutants to human health, such that pollutants with higher human health risks are given higher priority.

In some embodiments, the corresponding remediation strategy is generated based on the pollution type information of each groundwater pollution sub-area, including the following steps.

A pollution type of a soil pollution area within the industrial agglomeration area is acquired. Remote-sensing image data of areas near the soil pollution area is acquired through remote-sensing technology. The remote sensing image data of areas near the soil pollution area is analyzed to identify plant species in areas near the soil pollution area.

Corresponding remediation effects of the plant species in areas near the soil pollution area are acquired via big data analysis. A multi-head attention mechanism is used to determine whether a correlation exists between the remediation effects of the plant species in areas near the soil pollution area and the pollution type of the soil pollution area within the industrial agglomeration area.

If a correlation is found between the remediation effects of the plant species in areas near the soil pollution area and the pollution type of the soil pollution area within the industrial agglomeration area, the remediation priority of the soil pollution area is lowered.

If no correlation is found between the remediation effects of the plant species in areas near the soil pollution area and the pollution type of the soil pollution area within the industrial agglomeration area, the remediation priority of the soil pollution area is raised, and resources are allocated for remediation based on the remediation priority of the soil pollution area.

It should be noted that certain plant species are capable of exerting remediation effects on specific types of soil pollution. The roots of some plants can interact with microorganisms in the soil, thereby jointly contributing to the remediation of soil contamination. During this process, endophytic bacteria may absorb heavy metal elements and assist the plants in absorbing the heavy metal elements, thereby effectively reducing the adverse effects of the heavy metals on the plants. In addition, under the influence of microorganisms, plant root systems can develop well, promoting the effective absorption of nutrients and water, thereby further enhancing the ability of the plants to remediate soil pollution. When a correlation exists between the remediation effects of the plant species in areas near the soil pollution area and the pollution type of the soil pollution area within the industrial agglomeration area, the remediation priority of the soil pollution area is reduced, thereby facilitating the remediation of contamination.

In some embodiments, the method provided herein further includes the following steps. Volatility characteristic data information of a plurality of pollutants in the soil pollution area under different temperature conditions is acquired through big data analysis. Soil adsorption condition data information of the soil pollution area is acquired. Temperature variation data at each depth of the soil pollution area within a preset period is acquired. A volatility characteristic data at each depth of the soil pollution area within the preset period is obtained based on the volatility characteristic data information and the temperature variation data. A volatilization amount data of the soil pollution area is calculated based on the volatility characteristic data and the soil adsorption condition data information. The evaluation result is corrected based on the volatilization amount data to generate a final evaluation result.

It should be noted that, since certain pollution types are susceptible to volatilization under temperature influence, the method allows the evaluation result to be corrected based on the volatilization amount data, thereby generating the final evaluation result and improving the accuracy of predicting the diffusion of groundwater pollution.

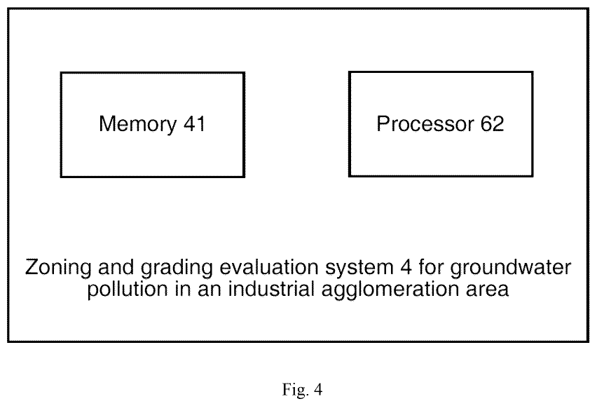

As shown in FIG. 4, the present disclosure also provides a system for zoning and grading evaluation of groundwater pollution in an industrial agglomeration area 4, including a memory 41 having stored thereon a program and a processor 62. The program, when executed by the processor 62, is configured to cause the processor 62 to perform steps of:
acquiring current enterprise data information of a plurality of enterprises within the industrial agglomeration area; and screening potential pollution-emitting enterprises based on the current enterprise data information;
constructing a pollution monitoring network based on the potential pollution-emitting enterprises; acquiring pollution monitoring data information through the pollution monitoring network; and acquiring soil pollution data information of areas near the potential pollution-emitting enterprises;
evaluating groundwater pollution within the industrial agglomeration area based on the pollution monitoring data information and the soil pollution data information to obtain an evaluation result; and
when the evaluation result is greater than a preset evaluation threshold, generating a graded early-warning signal based on the evaluation result, and generating a remediation strategy based on the graded early-warning signal.

In an embodiment of the system, groundwater pollution within the industrial agglomeration area is evaluated based on the pollution monitoring data information and the soil pollution data information to obtain the evaluation result, including the following steps.
Migration characteristic information of a plurality of pollutants in different soil types is acquired via big data analysis. A pollutant information database is constructed. Concentration information of each of the plurality of pollutants in the different soil types is input into the pollutant information database for storage.
A soil type of each of the potential pollution-emitting enterprises is acquired based on the soil pollution data information. Soil types of the potential pollution-emitting enterprises are input into the pollutant information database for matching, so as to obtain a soil pollution concentration information of each of the potential pollution-emitting enterprises.
When the pollution monitoring data information is greater than the soil pollution concentration information, a correlation between soil organic carbon content data and adsorption concentration information is acquired via big data analysis.
A current adsorption concentration information is corrected based on the correlation between the soil organic carbon content data and the adsorption concentration information, so as to generate a corrected adsorption concentration information. Based on the corrected adsorption concentration information and the pollution monitoring data information, the groundwater pollution within the industrial agglomeration area is evaluated to obtain the evaluation result.

In an embodiment of the system, based on the corrected adsorption concentration information and the pollution monitoring data information, groundwater pollution within the industrial agglomeration area is evaluated to obtain the evaluation result, including the following steps.
Soil survey data information of the industrial agglomeration area is acquired. Stratigraphic data is acquired based on the soil survey data information. A soil permeability coefficient for each stratum is acquired through the big data analysis based on the stratigraphic data.
Based on the soil permeability coefficient, a permeation rate of water in soil.
A diffusion condition of the plurality of pollutants in the soil within a preset period is predicted based on the permeation rate of water in the soil and the corrected adsorption concentration information.
A diffusion condition at each depth gradient in the stratigraphic data is acquired based on the diffusion condition of the plurality of pollutants in the soil within the preset period. A plurality of evaluation indicators are set. The diffusion condition at each depth gradient in the stratigraphic data is evaluated based on the plurality of evaluation indicators to obtain the evaluation result.

The present disclosure also provides a non-transitory computer-readable storage medium. The non-transitory computer-readable storage medium is configured for storing a program for zoning and grading evaluation of groundwater pollution within an industrial agglomeration area. The program is configured to be executed by the processor to implemented the method described above.

It should be understood that, in the above embodiments, the disclosed system and method may be implemented in other ways. The system described above are merely illustrative. For example, the division of the units is only a logical functional division, and alternative divisions may be employed in actual implementation. For instance, multiple units or components may be combined, or may be integrated into another system, or certain features may be omitted or not executed. In addition, the coupling or direct coupling, or communication connections between various components shown or discussed may be via some interfaces, and indirect coupling or communication connections between devices or units may be employed, which may be electrical, mechanical, or of other forms.

The units described above as separate components may or may not be physically separate, and the components shown as units may or may not correspond to physical units. Such units may be located in a single place or distributed across multiple networked units. Depending on practical requirements, some or all of the units may be selected to achieve the objectives of the embodiments of the present disclosure.

Furthermore, in the embodiments of the present disclosure, the functional units may be entirely integrated into a single processing unit, or each unit may be separately implemented as an individual unit, or two or more units may be integrated into a single unit. The integrated units may be implemented in hardware, or in a combination of hardware and software functional units.

Those skilled in the art can appreciate that all or part of the steps of the above-described method may be implemented by hardware associated with program instructions. The aforementioned program may be stored on a non-transitory computer-readable storage medium, and when executed, the program is configured to implement the steps of the above-described method. The non-transitory computer-readable storage medium may include, but is not limited to, a portable storage device, a read-only memory (ROM), a random-access memory (RAM), a magnetic disk, an optical disk, or any other medium capable of storing program code.

Alternatively, the above-described integrated units of the present disclosure, when implemented as software functional modules and marketed or used as independent products, may also be stored on a computer-readable storage medium. Based on this understanding, the technical solutions of the embodiments of the present disclosure, or the portions thereof that contribute to the prior art, can be embodied in the form of a software product. The computer software product is stored on a storage medium and includes a plurality of instructions configured to cause a computing device (which may be a personal computer, a server or a network device) to execute all or part of the methods of the embodiments of the present disclosure. The non-transitory computer-readable storage medium may include, but is not limited to, a portable storage device, ROM, RAM, a magnetic disk, an optical disk, or any other medium capable of storing program code.

The embodiments described above are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A method for zoning and grading evaluation of groundwater pollution in an industrial agglomeration area, comprising:
acquiring current enterprise data information of a plurality of enterprises within the industrial agglomeration area; and screening potential pollution-emitting enterprises based on the current enterprise data information;
constructing a pollution monitoring network based on the potential pollution-emitting enterprises; acquiring pollution monitoring data information through the pollution monitoring network; and acquiring soil pollution data information of areas near the potential pollution-emitting enterprises;
evaluating groundwater pollution within the industrial agglomeration area based on the pollution monitoring data information and the soil pollution data information to obtain an evaluation result; and
when the evaluation result is greater than a preset evaluation threshold, generating a graded early-warning signal based on the evaluation result, and generating a remediation strategy based on the graded early-warning signal.

2. The method of claim 1, wherein the step of screening the potential pollution-emitting enterprises based on the current enterprise data information of the plurality of enterprises within the industrial agglomeration area comprises:
performing feature extraction on the current enterprise data information to determine a production type for each of the plurality of enterprises within the industrial agglomeration area; and acquiring, via big data analysis, a production type set related to groundwater pollution;
determining whether the production type of each of the plurality of enterprises within the industrial agglomeration area falls within the production type set related to groundwater pollution;
if a production type of an enterprise among the plurality of enterprises is not within the production type set related to groundwater pollution, identifying the enterprise as a potential pollution-free enterprise;
if a production type of an enterprise among the plurality of enterprises is within the production type set related to groundwater pollution, acquiring production process information of the enterprise; obtaining, through the big data analysis, a product data associated with the production process information; analyzing, using a gray relational analysis method, a correlation degree between the product data and groundwater pollution; and when the correlation degree is greater than a preset correlation threshold, identifying and outputting the enterprise as a potential pollution-emitting enterprise.

3. The method of claim 1, wherein the step of constructing the pollution monitoring network based on the potential pollution-emitting enterprises comprises:
acquiring a production equipment arrangement area and a production procedure for each of the potential pollution-emitting enterprises; and identifying a potential discharge procedure associated with groundwater pollution based on the production procedure;
generating a deployment area of a plurality of monitoring devices based on the production equipment arrangement area and the potential discharge procedure associated with groundwater pollution; and
evenly deploying the plurality of monitoring devices within the deployment area to generate a plurality of monitoring nodes; and constructing the pollution monitoring network based on the plurality of the monitoring nodes.

4. The method of claim 1, wherein the step of evaluating groundwater pollution within the industrial agglomeration area based on the pollution monitoring data information and the soil pollution data information to obtain the evaluation result comprises:
acquiring, via big data analysis, migration characteristic information of a plurality of pollutants in different soil types; constructing a pollutant information database; and inputting concentration information of each of the plurality of pollutants in the different soil types into the pollutant information database for storage;
acquiring a soil type of each of the potential pollution-emitting enterprises based on the soil pollution data information; and inputting soil types of the potential pollution-emitting enterprises into the pollutant information database for matching, so as to obtain a soil pollution concentration information of each of the potential pollution-emitting enterprises;
when the pollution monitoring data information is greater than the soil pollution concentration information, acquiring, via the big data analysis, a correlation between soil physicochemical data and the soil pollution concentration information of the potential pollution-emitting enterprises;
correcting a current pollution concentration information based on the correlation between the soil physicochemical data and the soil pollution concentration information of the potential pollution-emitting enterprises, so as to generate a corrected pollution concentration information; and
based on the corrected pollution concentration information and the pollution monitoring data information, evaluating the groundwater pollution within the industrial agglomeration area to obtain the evaluation result.

5. The method of claim 4, wherein the step of based on the corrected pollution concentration information and the pollution monitoring data information, evaluating the groundwater pollution within the industrial agglomeration area to obtain the evaluation result comprises:
acquiring soil survey data information of the industrial agglomeration area; acquiring stratigraphic data based on the soil survey data information; and acquiring, through the big data analysis, a soil permeability coefficient for each stratum based on the stratigraphic data;
based on the soil permeability coefficient, calculating a permeation rate of water in soil;
predicting a diffusion condition of the plurality of pollutants in the soil within a preset period based on the permeation rate of water in the soil and the corrected pollution concentration information; and
acquiring a diffusion condition at each depth gradient in the stratigraphic data based on the diffusion condition of the plurality of pollutants in the soil within the preset period; setting a plurality of evaluation indicators; and evaluating the diffusion condition at each depth gradient in the stratigraphic data based on the plurality of evaluation indicators to obtain the evaluation result.

6. The method of claim 1, wherein the step of generating the graded early-warning signal based on the evaluation result, and generating the remediation strategy based on the graded early-warning signal comprises:
collecting groundwater pollution evaluation results within the industrial agglomeration area; setting a plurality of groundwater evaluation indicators; and
performing a groundwater pollution level evaluation on groundwater pollution survey data information of the industrial agglomeration area based on the plurality of groundwater evaluation indicators to generate a groundwater pollution level evaluation result;
based on the groundwater pollution level evaluation result, performing zoning and degrading early warning on the industrial agglomeration area to obtain an early-warning level for each groundwater pollution sub-area within the industrial agglomeration area;
acquiring a pollution type information of each groundwater pollution sub-area within the industrial agglomeration area; and acquiring, through big data analysis, a health hazard degree of each groundwater pollution sub-area based on the pollution type information of each groundwater pollution sub-area; and
generating a priority ranking result in a descending order based on the health hazard degree of each groundwater pollution sub-area; generating a priority remediation strategy based on the priority ranking result; and simultaneously generating a corresponding remediation strategy based on the pollution type information of each groundwater pollution sub-area.

7. A system for zoning and grading evaluation of groundwater pollution in an industrial agglomeration area, comprising:
a memory having stored thereon a program; and
a processor;
wherein the program, when executed by the processor, is configured to cause the processor to perform steps of:
acquiring current enterprise data information of a plurality of enterprises within the industrial agglomeration area; and screening potential pollution-emitting enterprises based on the current enterprise data information;
constructing a pollution monitoring network based on the potential pollution-emitting enterprises; acquiring pollution monitoring data information through the pollution monitoring network; and acquiring soil pollution data information of areas near the potential pollution-emitting enterprises;
evaluating groundwater pollution within the industrial agglomeration area based on the pollution monitoring data information and the soil pollution data information to obtain an evaluation result; and
when the evaluation result is greater than a preset evaluation threshold, generating a graded early-warning signal based on the evaluation result, and generating a remediation strategy based on the graded early-warning signal.

8. The system of claim 7, wherein the step of evaluating groundwater pollution within the industrial agglomeration area based on the pollution monitoring data information and the soil pollution data information to obtain the evaluation result comprises:
acquiring, via big data analysis, migration characteristic information of a plurality of pollutants in soil and groundwater; constructing a pollutant information database; and inputting concentration information of each of the plurality of pollutants in the soil and groundwater into the pollutant information database for storage;
acquiring a soil type of each of the potential pollution-emitting enterprises based on the soil pollution data information; and inputting soil types of the potential pollution-emitting enterprises into the pollutant information database for matching, so as to obtain a soil and groundwater pollution concentration information of each of the potential pollution-emitting enterprises;
when the pollution monitoring data information is greater than the soil and groundwater pollution concentration information, acquiring, via big data analysis, a correlation between soil physicochemical data and the soil and groundwater pollution concentration information of the potential pollution-emitting enterprises;
correcting a current pollution concentration information based on the correlation between the soil physicochemical data and the soil and groundwater pollution concentration information of the potential pollution-emitting enterprises, so as to generate a corrected pollution concentration information; and
based on the corrected pollution concentration information and the pollution monitoring data information to obtain the evaluation result, evaluating the groundwater pollution within the industrial agglomeration area.

9. The system of claim 8, wherein the step of based on the corrected pollution concentration information and the pollution monitoring data information to obtain the evaluation result, evaluating the groundwater pollution within the industrial agglomeration area comprises:
acquiring soil survey data information of the industrial agglomeration area, and acquiring stratigraphic data based on the soil survey data information; and acquiring, through the big data analysis, a soil permeability coefficient for each stratum based on the stratigraphic data;
based on the soil permeability coefficient, calculating a permeation rate of water in soil;
predicting a diffusion condition of the plurality of pollutants in the soil within a preset period based on the permeation rate of water in the soil and the corrected pollution concentration information; and
acquiring a diffusion condition at each depth gradient in the stratigraphic data based on the diffusion condition of the plurality of pollutants in the soil within the preset period, setting a plurality of evaluation indicators, and evaluating the diffusion condition at each depth gradient in the stratigraphic data based on the plurality of evaluation indicators to obtain the evaluation result.

10. A non-transitory computer-readable storage medium, wherein the non-transitory computer-readable storage medium is configured for storing a program for zoning and grading evaluation of groundwater pollution in an industrial agglomeration area; and
the program is configured to be executed by a processor to implement the method of claim 1.
